(19) United States
(12) Patent Application Publication
(10) Pub. No.: US 2011/0174116 A1
(43) Pub. Date: Jul. 21, 2011

(54) HAMMER ASSEMBLY HAVING MEANS FOR HOLDING NAIL

(75) Inventor: Sorwing Lin, TAICHUNG COUNTY (TW)

(73) Assignee: LUCKY-BRAND INDUSTRIAL CO., LTD., TAICHUNG COUNTY (TW)

(21) Appl. No.: 12/750,649

(22) Filed: Mar. 30, 2010

(30) Foreign Application Priority Data
Jan. 21, 2010 (TW) 099101687

(51) Int. Cl. B25D 1/04

(52) U.S. Cl. 81/23

(57) ABSTRACT

A hammer assembly having means for holding a nail includes a hammer and a nail holder. The nail holder is detachably mounted to the hammer to expose its one part or entirety outside an external surface of the hammer. When the nail holder is separated from the hammer, the nail holder can be used for holding a nail which is to be hit by the hammer. In this way, the user does not need to hold the nail by his or her hand to prevent the user's hand from any accidental hit of the hammer. Besides, when the nail holder is not needed, the user can mount it to the hammer. Therefore, the hammer assembly can be operated safely and stored conveniently.

### BACKGROUND OF THE INVENTION

1. Field of the Invention

The present invention relates generally to a hammer assembly, and more particularly, to a hammer assembly having means for holding a nail.

2. Description of the Related Art

When a conventional hammer is operated for hitting a nail, a user usually holds the nail by his or her hand to allow the nail to stand on where the nail is stuck. However, such operation may accidentally hammer the user's hand, especially for the inexperienced user, thus being dangerous to a certain degree to frighten the user away from doing so.

As a result, a device instead of the user's hand for holding a nail was developed to keep the nail upright at a particular position. Such device is shaped like a long bar and can be held by the user's hand, while the nail is hit by a hammer, for holding the nail at where the nail is to be stuck and the user hand is away from the nail. In this way, the device avoids movement and further prevents the user's hand from injury resulting from the hammer's accidental hit. However, such device is usually much smaller than the hammer, such that the user, especially a person who seldom operates the hammer, may easily ignore the device, after they are stored somewhere, and may forget where the device is stored to fail to find it all of a sudden while needing to hammer a nail.

### SUMMARY OF THE INVENTION

The primary objective of the present invention is to provide a hammer assembly having means for holding a nail; the hammer assembly can be operated safely and stored conveniently.

The foregoing objective of the present invention is attained by the hammer assembly composed of a hammer and a nail holder. The nail holder is detachably mounted to the hammer to expose its one part or entirety outside an external surface of the hammer. When the nail holder is separated from the hammer, the nail holder can be used for holding a nail which is to be hit by the hammer. Before the user hits the nail by the hammer, the user can align a positioning hole of the nail holder with where the nail is to be stuck and then put the nail in the positioning hole to enable the nail to stand at that position. In this way, the user does not need to hold the nail by his or her hand to prevent the user's hand from any accidental hit of the hammer. Besides, when the nail holder is not needed, the user can mount it to the hammer in such a way that it will not happen that the user cannot find the nail holder while needing the nail holder for hammering a nail.

### BRIEF DESCRIPTION OF THE DRAWINGS

FIG. 1 is an exploded view of a first preferred embodiment of the present invention.

FIG. 2 is a front view of the first preferred embodiment of the present invention.

FIG. 3 is a sectional view taken along a line 3-3 indicated in FIG. 2, showing a pattern of combination of the nail holder and the hammer.

FIG. 4 is a schematic view of the first preferred embodiment of the present invention in operation.

FIG. 5 is similar to FIG. 3, showing another pattern of combination of the nail holder and the hammer.

FIG. 6 is similar to FIG. 3, showing another pattern of combination of the nail holder and the hammer.

FIG. 7 is similar to FIG. 3, showing another pattern of combination of the nail holder and the hammer.

FIG. 8 is another exploded view of the first preferred embodiment of the present invention.

FIG. 9 is a side view of a second preferred embodiment of the present invention.

FIG. 10 is a front view of a third preferred embodiment of the present invention.

FIG. 11 an exploded view of a fourth preferred embodiment of the present invention.

FIG. 12 is a schematic view of the fourth preferred embodiment of the present invention.

### DETAILED DESCRIPTION OF PREFERRED EMBODIMENTS

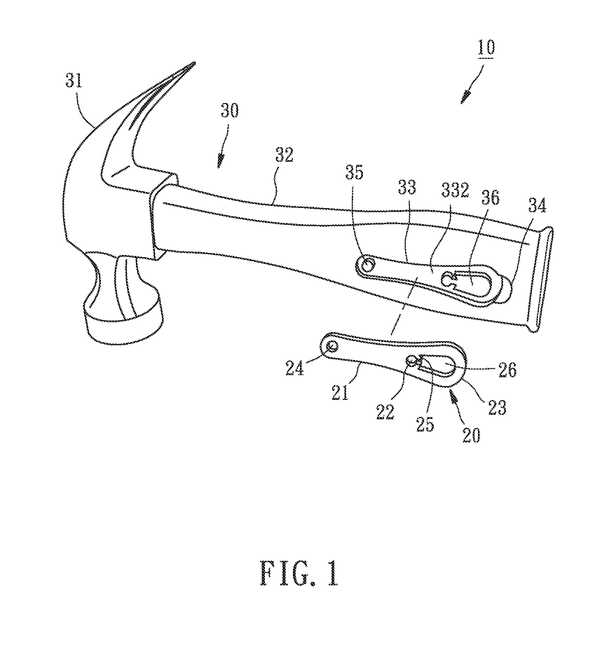

Referring to FIGS. 1-3, a hammer assembly 10 having means for hammering a nail in accordance with a first preferred embodiment of the present invention is composed of a nail holder 20 and a hammer 30.

The nail holder 20 is plate-shaped and includes an elongated body portion 21 and an arc-shaped head portion 23 extending from one end of the body portion 21 and being wider than the body portion 21. The head portion 23 has a positioning hole 22, a reception hole 26, and a passage 25 for communication between the positioning hole 22 and the reception hole 26. The body portion 21 has a fastening hole 24.

The hammer 30 is the same as the common one in appearance and function and includes a hammer portion 31 and a handlebar 32. The handlebar 32 has a positioning recession 33, a finger hole 34 formed beside the positioning recession 33, a first joint portion 35, and a second joint portion 36. Each of the first and second joint portions 35 and 36 protrudes outward from a bottom side of the positioning recession 33.

The positioning recession 33 includes a complementary shape to that of the nail holder 20. The shapes and positions of the first and second joint portions 35 and 36 correspond to those of the positioning hole 22, the fastening hole 24, and the reception hole 26. The height of each of the first and second joint portions 35 and 36 is identical to the depth of the positioning recession 33. When the nail holder 20 is mounted to the positioning recession 33, the first joint portion 35 is combined into the fastening hole 24 and the second joint portion 36 is combined into the positioning hole 22 and the reception hole 26. In this way, the nail holder 20 is detachably mounted to the hammer 30 and exposed outside the handlebar 32.

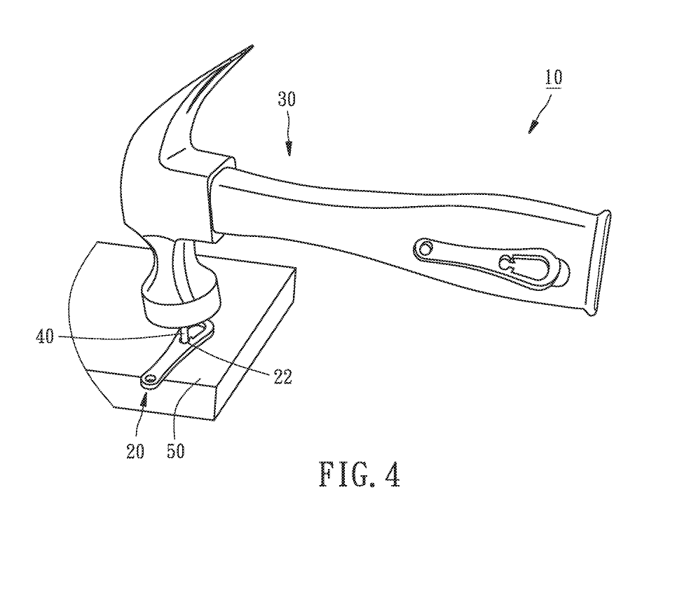

Referring to FIG. 4, the hammer assembly 10 is operated to hit a nail 40 onto an object 50, like a board or a wall. While operating the hammer assembly 10, the user can detach the nail holder 20 from the handlebar 32 by applying a force to the finger hole 34 and the second joint portion 36 with his or her fingers to separate the nail holder 20 from the hammer 30. Next, the user holds the body portion 21 of the nail holder 20 and then moves the nail holder 20 onto the object 50 at where the positioning hole 22 is aligned with a position, into which the user intends to stick the nail 40. After that, the user can put the nail 40 into the positioning hole 22 to allow the nail 40 to stand in the positioning hole 22, and then hit the nail 40 into the object 50 by the hammer 30. In this way, it will not happen that the hammer 30 hits the user's finger.

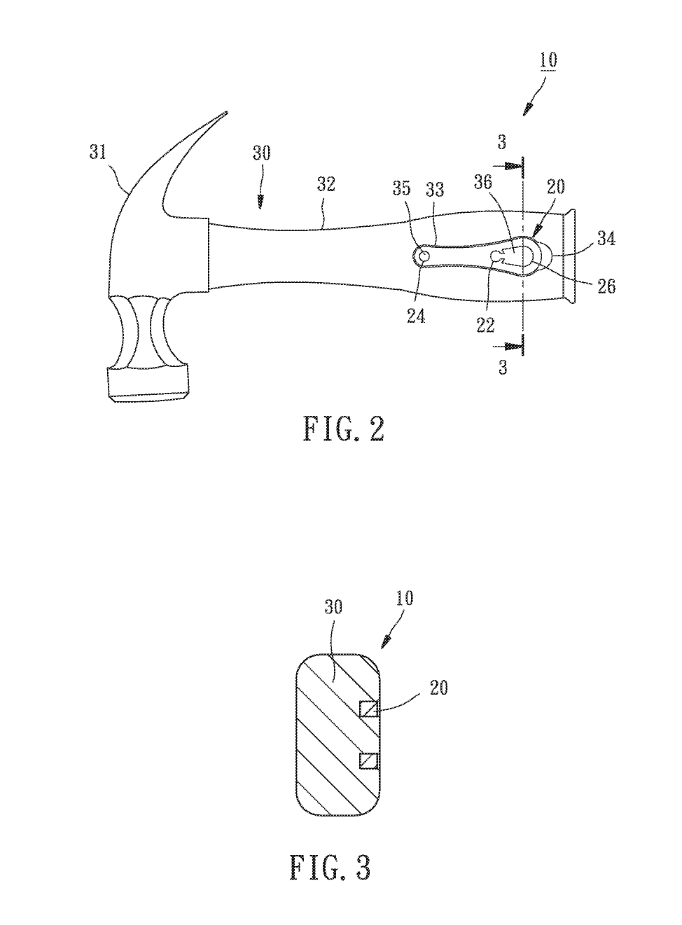

Referring to FIG. 2 again, when the hammer assembly 10 is idle or the nail holder 20 is not needed, the nail holder 20 can be fixedly mounted to the positioning recession 33 to enable the nail holder 20 to be tight fit to the first and second joint portions 35 and 36. In this way, the nail holder 20 is connected with the hammer 30 to become one piece and thus can be stored together. Besides, when the user hits other objects by the hammer assembly 10, the nail holder 20 does not disengage from the hammer 30 due to the tremor resulting from the hammering.

It is to be noted that the nail holder 20 is though provided for the nail 40 to pass through and to be positioned, the fastening hole 24 is though provided for increasing the combinative area between the nail holder 20 and the hammer 30, and the reception hole 26 is though provided for the user's finger to apply a force for taking out the nail holder 20, but they can have more functions. For example, the fastening hole 24 can be provided for a nail having the same diameter as that of the fastening hole 24 to pass through and to be positioned; the reception hole 26 can increase the combinative area between the nail holder 20 and the hammer 30. Besides, the nail holder 20 can only have the positioning hole 22 without the fastening hole 24 and the reception hole 26 as long as the nail holder 20 can be connected with the hammer 30.

In addition, how the nail holder 20 is combined into the hammer 30 is not limited to what FIG. 3 shows and can be alternatives as follows.

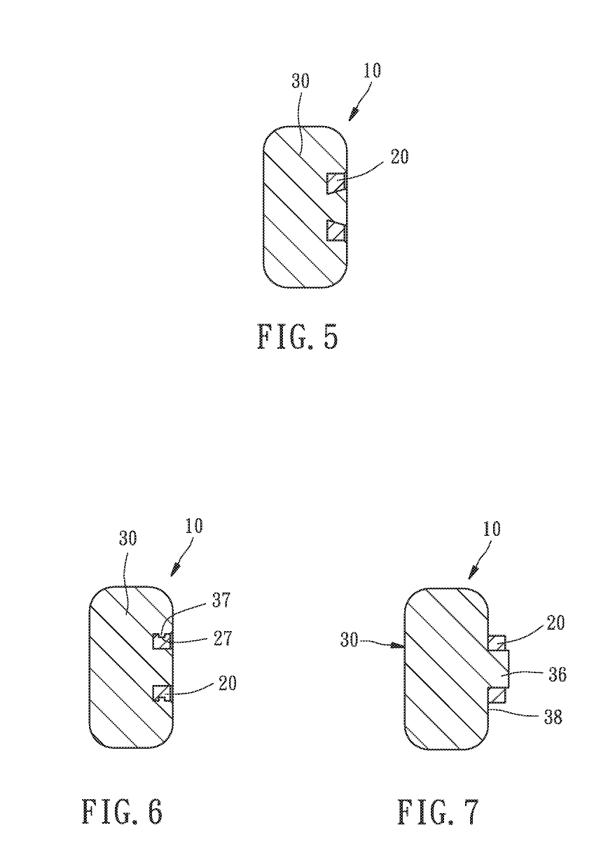

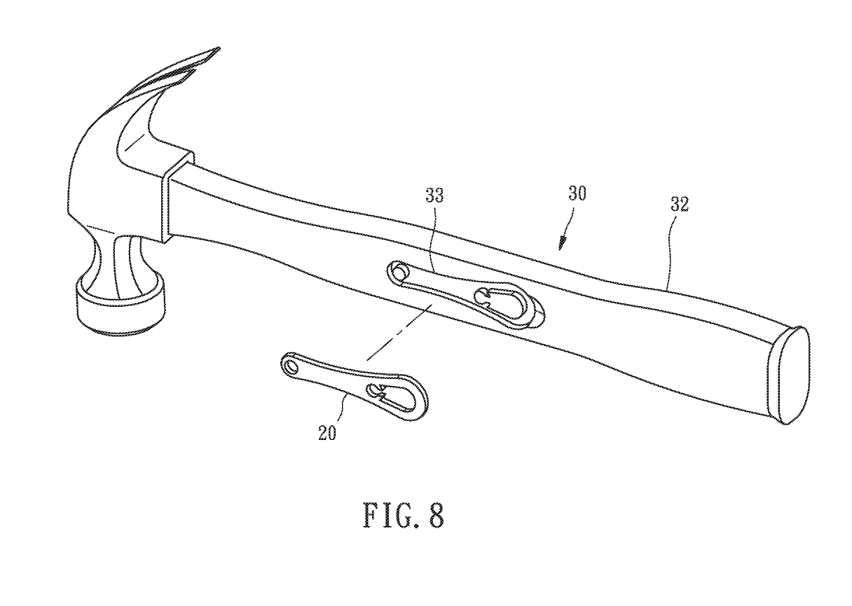

Referring to FIG. 5, each of the nail holder 20 and the hammer 30 alternatively includes an inclined portion, and the nail holder 20 is combined into the hammer 30 more firmly by the inclined portions engaging each other. Referring to FIG. 6, each of the nail holder 20 and the hammer 30 alternatively includes a positioning slot 27 and a locking portion 37 for further enabling the nail holder 20 and the hammer 30 to engage each other more firmly. Referring to FIG. 7, the hammer 30 does not have the positioning recession 33, and the first and second joint portions 35 and 36 protrude outward from an external surface 38 of the hammer 30 for the nail holder 20 to be sleeved onto. Referring to FIG. 8, when the handlebar 32 of the hammer 30 is relatively longer, the positioning recession 33 can be mounted close to a center of the handlebar 32.

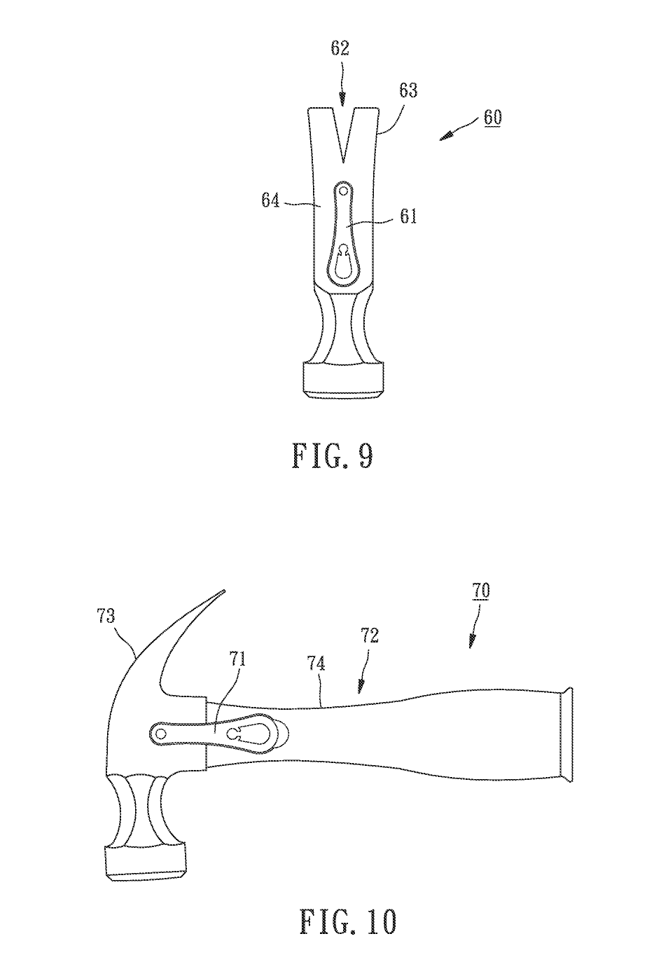

As mentioned above, the nail holder 20 is detachably connected with the handlebar 32. However, referring to FIG. 9, a hammer assembly 60 having means for holding a nail in accordance with a second preferred embodiment of the present invention is similar to that of the first embodiment, having the following difference. The nail holder 61 is connected with the hammer portion 63 of the hammer 62. Specifically, the nail holder 61 is curved and detachably connected with an arc-shaped portion 64 of the hammer portion 63, which has the same radian as that of the nail holder 61. In this way, the hammer assembly 60 can also attain the objective of the present invention.

Referring to FIG. 10, a hammer assembly 70 having means for holding a nail in accordance with a third preferred embodiment of the present invention is similar to that of the first embodiment, having the following difference. The nail holder 71 is connected with a joint between the hammer portion 73 and the handlebar 74 of the hammer 72. In fact, the nail holder can alternatively be connected with other positions of the hammer assembly as long as the hammer assembly can function normally.

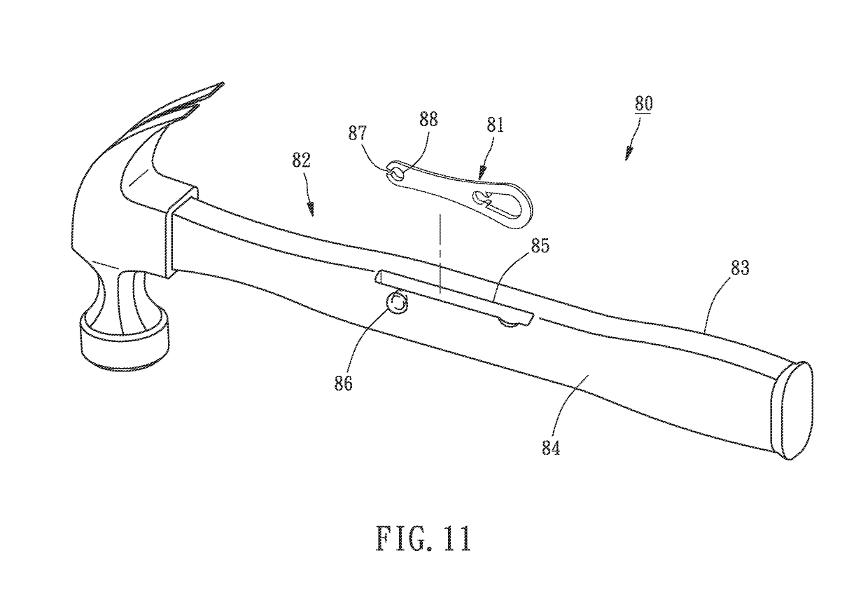

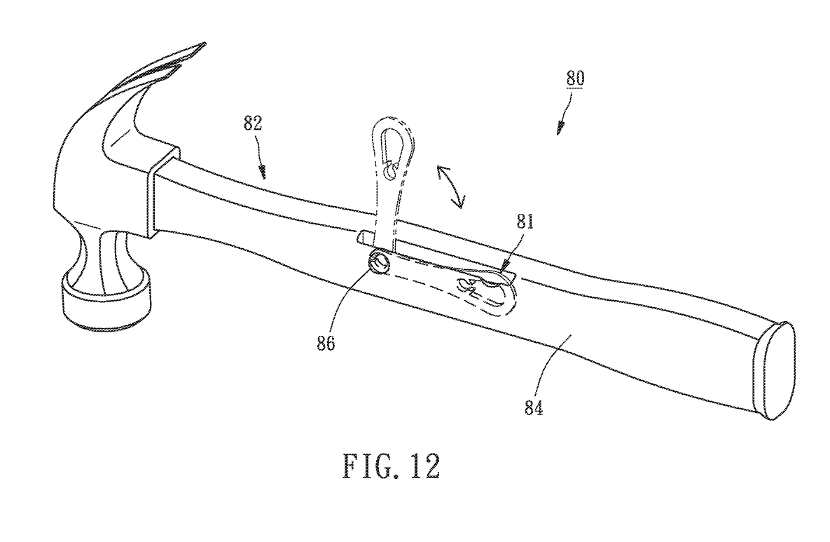

Referring to FIGS. 11 and 12, a hammer assembly 80 having means for holding a nail in accordance with a fourth preferred embodiment of the present invention is similar to that of the first embodiment, having the following difference. The handlebar 83 of the hammer 82 includes a slot 85 recessed downward from an external surface 84 and a pivot 86 formed in the slot 85. The nail holder 81 includes a gap 87 in communication with the fastening hole 88. The gap 87 can be forced to engage the pivot 86 to allow the nail holder 81 to pivot into or out of the slot 85. When the nail holder 81 pivots into the slot 85, a part of the nail holder 81 is exposed outside the external side 84 of the handlebar 83. In this way, after the nail holder 81 pivots out of the slot 85, the user can disengage the gap 87 from the pivot 86 to take out the nail holder 81.

Although the present invention has been described with respect to specific preferred embodiments thereof, it is in no way limited to the specifics of the illustrated structures but changes and modifications may be made within the scope of the appended claims.

What is claimed is:

1. A hammer assembly comprising:
a hammer having an external surface; and
a nail holder detachably mounted to the hammer and exposing a part or the entirety of itself outside the external surface of the hammer; when the nail holder is separated from the hammer, the nail holder can be used for holding a nail which is to be stuck by the hammer.

2. The hammer assembly as defined in claim 1, wherein the hammer comprises a positioning recession formed at the external surface and the nail holder can be fixedly mounted to the positioning recession.

3. The hammer assembly as defined in claim 2, wherein the nail holder comprises a fastening hole and the hammer further comprises a first joint portion formed at the external surface and corresponding to the fastening hole, the first joint portion protruding outward from a bottom side of the positioning recession, the fastening hole being mounted to the first joint portion.

4. The hammer assembly as defined in claim 2, wherein the hammer further comprises a finger hole formed beside the positioning recession.

5. The hammer assembly as defined in claim 2, wherein the nail holder comprises a positioning hole and the hammer further comprises a second joint portion formed at the external surface and corresponding to the positioning hole, the second joint portion protruding outward from a bottom side of the positioning recession, the positioning hole being mounted to the second joint portion.

6. The hammer assembly as defined in claim 1, wherein the hammer comprises a handlebar and the nail holder is detachably connected with the handlebar.

7. The hammer assembly as defined in claim 1, wherein the hammer comprises a hammer portion and the nail holder is detachably connected with the hammer portion.

8. The hammer assembly as defined in claim 1, wherein the nail holder comprises a positioning hole and a reception hole abutting and communicating with the positioning hole.

9. The hammer assembly as defined in claim 1, wherein the nail holder comprises a fastening hole and a gap communicating with the fastening hole, the gap engaging the hammer to allow the nail holder to pivot relative to the hammer.
